(19) United States
(12) Patent Application Publication
(10) Pub. No.: US 2021/0279798 A1
(43) Pub. Date: Sep. 9, 2021

(54) AXIS NEGOTIATION SYSTEM AND METHOD

(71) Applicant: WEMATCH.LIVE R&D LTD., Herzliya (IL)

(72) Inventor: Gregory MIMOUN, Raanana (IL)

(73) Assignee: WEMATCH.LIVE R&D LTD., Herzliya (IL)

(21) Appl. No.: 17/260,048

(22) PCT Filed: Jul. 16, 2019
(86) PCT No.: PCT/IB2019/056085

§ 371 Date: Jan. 13, 2021

Related U.S. Application Data
(60) Provisional application No. 62/698,301, filed on Jul. 16, 2018.

(51) Int. Cl. G06Q 40/04; G06F 9/451

(52) U.S. Cl. CPC G06Q 40/04; G06F 9/451

(57) ABSTRACT

A computer-implemented method of negotiating a trade of a product or a service between a plurality of buyers and sellers, the method includes using a GUI on computing devices of the plurality of buyers and sellers, displaying on the computing devices a one-dimensional axis divided into two sections, a first section to display on the axis offers made by buyers, and an opposing second section to display offers made by seller. The method additionally includes arranging the buyer offers on the first section in descending order based on the buyer prices, with the buyer offer with the highest price most proximal to the second section and that with the lowest price most distant from the second section. The method further includes arranging the seller offers on the second section in ascending order based on the seller prices, with the seller offer with the lowest price most proximal to the first section and that with the highest price most distant from the first section. The method additionally includes displaying on the computing devices the axis including the arranged first section and the arranged second section, allowing a buyer with the highest price and a seller with the lowest price to negotiate with each other by selecting negotiation actions on the GUI, and displaying negotiating notifications on the axis responsive to the selecting.

### CROSS-REFERENCE TO RELATED APPLICATIONS

This application claims the benefit of priority from U.S. Provisional Patent Application No. 62/698,301 filed 16 Jul. 2019, the contents of which are incorporated herein by reference in their entirety.

### FIELD OF THE INVENTION

The present invention, in some embodiments thereof, relates to trading systems, and, more particularly, but not exclusively, to a system and method for negotiating between anonymous trade parties.

### BACKGROUND OF THE INVENTION

Trading may generally be defined as the act of buying, selling or exchanging products or service. Technological advancements, with time, have allowed trading to evolve to a state where products and/or services may be sold on-line and may be equally purchased on-line through on-line platforms.

One sector which has seen a great advance in on-line trading is the stocks and securities investment sector. Prior to the Internet, investors had to place an order through a stockbroker, in person or via telephone. The brokerage firm then entered the order in their system, which was linked to trading floors and exchanges. With the advent of the Internet, individuals and traders may now buy and sell securities over an electronic network using an on-line trading platform. The online trading platform acts as the hub, allowing investors to purchase and sell such securities as fixed income, equities/stock, options, and mutual funds. Included with the platform are tools to track and monitor securities, portfolios and indices, as well as research tools, real-time streaming quotes and up-to-date news releases.

Some on-line trading platforms maintain both buyers and sellers anonymous in order to prevent their entering into direct negotiation, potentially bypassing an intermediary. One such platform is described in U.S. 2010/0005030 to DePetris et al. which discloses “A computer program provides a screen-based interface enabling anonymous negotiation between a buyer and a seller. Parties wishing to trade enter values into fields of a screen-based interface, thereby creating a trading interest, and may select from terms associated with each of the fields to augment the trading interest. The parties may also specify counter-party filtering criteria in the trading interest. The computer program then displays to the creator of the trading interest any previously entered trading interests that might result in a trade, and that satisfy the counter-party filtering criteria, if any. The computer program also displays the new trading interest to the creators of the previously entered trading interests. Two of the parties may agree to negotiate using structured messages that maintain their anonymity. The identities of the counter-parties need not be known to each other as, after a trade agreement is reached, a central clearing party becomes the counter-party to each of the parties via a novation”.

### SUMMARY OF THE PRESENT INVENTION

There is provided, in accordance with an embodiment of the present invention, a computer-implemented method of negotiating a trade of a product or a service between a plurality of buyers and sellers, the method may include using a GUI on computing devices of the plurality of buyers and sellers, displaying on the computing devices a one-dimensional axis divided into two sections, a first section to display on the axis offers made by buyers, and an opposing second section to display offers made by seller. The axis may be positioned horizontally. The method may additionally include arranging the buyer offers on the first section in descending order based on the buyer prices, with the buyer offer with the highest price most proximal to the second section and that with the lowest price most distant from the second section. The method may additionally include arranging the seller offers on the second section in ascending order based on the seller prices, with the seller offer with the lowest price most proximal to the first section and that with the highest price most distant from the first section. The method may additionally include displaying on the computing devices the axis including the arranged first section and the arranged second section, allowing a buyer with the highest price and a seller with the lowest price to negotiate with each other by selecting negotiation actions on the GUI, and displaying negotiating notifications on the axis responsive to the selecting.

In some embodiments, the method may include displaying on the first section, for each buyer offer, a buyer price, and displaying on the second section, for each seller offer, a seller price. The method may additionally include displaying on the first section, for each buyer offer, a buying quantity, and displaying on the second section, for each seller offer, a selling quantity.

In some embodiments, the method may include communicating to the plurality of buyers and sellers that an offer is being withdrawn from trading but will remain displayed on the axis by displaying a notification on the axis. The method may additionally include communicating to the plurality of buyers and sellers that the withdrawn offer is being revived for trading by displaying a notification on the axis. The method may additionally include communicating to the plurality of buyers and sellers that a price is non-negotiable by displaying a notification on the axis.

In some embodiments, the method may include selecting a direct offer negotiation action on the GUI and displaying an improved offer on the axis only to the highest price buyer and the lowest price seller. The method may additionally include selecting a repeat offer negotiation action on the GUI and displaying a repeated offer on the axis only to the highest price buyer and the lowest price seller.

In some embodiments, the method may include selecting a “meet in the middle” negotiation action on the GUI and displaying a “meet in the middle” notification on the axis only to the highest price buyer and the lowest price seller. The method may additionally include selecting an “are you there?” negotiation action on the GUI and displaying an “are you there” notification on the axis only to the highest price buyer and the lowest price seller.

In some embodiments, the method may include the GUI displaying the amount of time the offers of the highest price buyer and of the lowest price seller are valid to the plurality of buyers and sellers. The method may additionally include the GUI displaying the offers of the highest price buyer and of the lowest price seller is valid to the plurality of buyers and sellers. The method may additionally include the GUI displaying a message of an ongoing negotiation to the plurality of buyers and sellers.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a block diagram of an exemplary axis negotiation system (ANS) which may be used to practice the teachings disclosed herein, according to an embodiment of the present invention;

FIG. 2 schematically illustrates the negotiation engine (NE) in the ANS, according to an embodiment of the present invention;

FIG. 3 schematically illustrates an exemplary layout for the graphics unit interface (GUI) which may be used with all ANS user computing devices, according to an embodiment of the present invention;

FIG. 4A schematically illustrates the operation of the ANS in a first scenario of an exemplary trading session which includes negotiations between users, as visualized on the GUI of the users, according to an embodiment of the present invention;

FIG. 4B schematically illustrates the operation of the ANS in a second scenario of an exemplary trading session which includes negotiations between users, as visualized on the GUI of the users, according to an embodiment of the present invention;

FIG. 4C schematically illustrates the operation of the ANS in a third scenario of an exemplary trading session which includes negotiations between users, as visualized on the GUI of the users, according to an embodiment of the present invention;

FIG. 4D schematically illustrates the operation of the ANS in a fourth scenario of an exemplary trading session which includes negotiations between users, as visualized on the GUI of the users, according to an embodiment of the present invention;

FIG. 4E schematically illustrates the operation of the ANS in a fifth scenario of an exemplary trading session which includes negotiations between users, as visualized on the GUI of the users, according to an embodiment of the present invention;

FIG. 4F schematically illustrates the operation of the ANS in a sixth scenario of an exemplary trading session which includes negotiations between users, as visualized on the GUI of the users, according to an embodiment of the present invention;

FIG. 4G schematically illustrates the operation of the ANS in a seventh scenario of an exemplary trading session which includes negotiations between users, as visualized on the GUI of the users, according to an embodiment of the present invention;

FIG. 4H schematically illustrates the operation of the ANS in an eighth scenario of an exemplary trading session which includes negotiations between users, as visualized on the GUI of the users, according to an embodiment of the present invention;

FIG. 4I schematically illustrates the operation of the ANS in a ninth scenario of an exemplary trading session which includes negotiations between users, as visualized on the GUI of the users, according to an embodiment of the present invention;

FIG. 4J schematically illustrates the operation of the ANS in a tenth scenario of an exemplary trading session which includes negotiations between users, as visualized on the GUI of the users, according to an embodiment of the present invention;

FIG. 4K schematically illustrates the operation of the ANS in an eleventh scenario of an exemplary trading session which includes negotiations between users, as visualized on the GUI of the users, according to an embodiment of the present invention;

FIG. 4L schematically illustrates the operation of the ANS in a twelfth scenario of an exemplary trading session which includes negotiations between users, as visualized on the GUI of the users, according to an embodiment of the present invention; and

FIG. 4M schematically illustrates the operation of the ANS in a thirteenth scenario of an exemplary trading session which includes negotiations between users, as visualized on the GUI of the users, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Throughout the detailed description, reference may be made to entities such as users, buyers, sellers, and market players. It may be appreciated by the skilled person that, although these entities may be assumed to be humans, they may not necessarily be limited to humans and may include computer-based systems including AI systems and Machine Learning systems, among others.

Applicant has realized that negotiation may be the most important aspect of trading as it may contribute to closing a deal. A buyer seeking a product or a service may be faced with one of three situations; (1) to close a deal because the seller is offering exactly what he or she is seeking to buy and the seller's conditions are acceptable to the buyer, (2) to accept what the seller is offering once the seller and/or the buyer have made possible concessions through negotiation, and (3) to reject the seller's offer altogether regardless of any possible concessions. Applicant has additionally realized that existing on-line trading platforms do not address the negotiating aspect and only serve to provide an execution platform for, sometimes anonymous, buying and selling, resulting in, many deals not being closed.

Applicant has devised a negotiation system (hereinafter may be referred to as “axis negotiation system”) including an on-line trading platform which uses a dedicated graphic unit interface (GUI) to provide equal visibility and transparency to all market players (buyers and sellers) using the system, and which provides mechanisms to allow the users to negotiate with one another while remaining anonymous. The GUI may allow the market players to see, practically at a glimpse, what is the real-time trading situation in the market for a specific product or service. The GUI may additionally allow each buyer and seller, also practically at a glimpse, to view their position in the market relative to other market players. Responsive to viewing their position in the market, the GUI may allow the market players to take negotiating actions through the use of a series of action mechanisms which may allow them to improve their position, to remain in the same position, to withdraw their position, or to negotiate with counterpart market players. The action mechanisms may include action buttons which may be used to communicate actions, in real-time, publicly to all market players, or privately to the highest price seller and lowest price seller, and may be represented by displayed action notifications on the axis.

The axis negotiation system may include a negotiation engine which may allow a buyer and a seller to privately communicate with one another, using the GUI, in order to enter into negotiations while remaining anonymous. The negotiation engine may additionally allow a buyer to privately negotiate with multiple sellers, or the inverse, to allow a seller to negotiate with multiple buyers. During the negotiations, all market players may be made aware that a negotiation is going on but are not aware of any of the details of the negotiation unless a deal is reached. When a deal is reached, the market players may be informed of the price level at which the trade was made, and the volume of the trade. Private negotiations may be conducted between a buyer offering the highest buying price (hereinafter “highest price buyer”) and a seller offering the lowest selling price (hereinafter “lowest price seller”). For example, the negotiation system may promote a private negotiation between a buyer with a buying price offer of 7 and a seller with a selling price offer of 8 if there are no buyer offers or seller offers in between. Optionally, a buyer and a seller may enter into private negotiations based on criteria other than smallest price difference, for example, if quantity amounts may be fully satisfied, among other possible negotiation criteria. The negotiation engine may additionally allow a market player to express behavior which may be displayed through the GUI to all the market players.

In an embodiment of the present invention, the GUI may display to all the market players a one-dimensional axis (hereinafter referred to as “axis”) wherein may be viewed all the offers may by the buyers and the sellers. The axis, which may be horizontally displayed, may be divided into two sections, a first axis section on which may be displayed all the buyers offers to buy a specific product or service, and a second opposing section on which may be displayed all the seller offers for that product or service. Alternatively, the axis may be displayed vertically or slopingly at an angle. The buyers' offers may be displayed on the first axis section according to the price value of each offer, ranked in descending order with the highest buyer price closest to the second axis section and the lowest buyer price furthest away from the second axis section. The sellers' offers may be ranked on the second axis section in ascending order with the lowest selling price closest to the first axis section and the highest selling price furthest away from the first axis section. Consequently, when displayed on the axis, the highest price buyer may be closest to the lowest price seller. It may then be readily appreciated that by displaying all buying prices and all selling prices along the axis in a ranked order, a quick view of the axis will provide a complete picture as to the position of each anonymous player in the market.

In some embodiments, the buyer and seller information associated with each offer and displayed on the axis may include each buyer's and seller's price, the quantity being seeked by each buyer and the quantity offered for sale by each seller, and optionally the number of buyers and sellers at the same price levels. When there is more than one buyer or seller at a same price level, the information displayed may include that of the first buyer or seller to post a buying offer or a selling offer, respectively. Additionally displayed on the axis may be the action notifications by the users, representative of buyer and seller negotiation actions. In the detailed description, all reference to information displayed on the axis may also refer to information which may be placed proximal to the axis, above and below the axis, and include the aforementioned price information, quantity information, number of players at same price level, and the negotiation actions.

In addition to the information displayed on the axis, the GUI may display to all the market players the highest buyer price offer and the lowest seller price offer and the amount of time the price offer is valid (amount of time until the price offer expires). For example, the highest price buyer may indicate that his or her buying offer is valid until the end of the day (EOD) while the lowest price seller may indicate that his or her offer is valid for a limited amount of time, for example, three hours.

In some embodiments, the GUI may allow the market players to input their buying offers or selling offers and may display them on the axis to all market players. It may additionally allow them to modify their offers and also to enter into private negotiations with counterparts.

In some embodiments, a negotiation action which may be taken by a market player, as part of a negotiation process, may be to communicate a private notification through the GUI and by means of the action buttons to the counterpart with the closest counteroffer. The private notification may only be displayed on the axis of the highest price buyer and the lowest price seller, and may not be viewed by the rest of the market players. The private notification may be in the form of an improved offer and may be limited in time. Additionally, the private notification may include a “let's meet in the middle” notification which may be an offer to equally divide the price difference between the buyer and seller (divide the price difference in half). Additionally, the private action notification may include a “repeat” notification wherein during a negotiation, one of the parties may not wish to change the price and, in response to an offer from the counterparty, may display the notification indicating that the existing offer is being repeated. Additionally, the private notification may include a “last show” notification wherein one of the parties provides an offer (or improved offer) and limits the time duration of the offer, for example to 15 minutes. Additionally, the private notification may include an “are you there?” notification wherein a party willing to negotiate (or to trade) communicates a notification directed to the closest counterpart who may have previously indicated their unwillingness to continue trading on the axis to all the market players, querying if they are open to trade.

During the negotiation, the offers and counteroffers made by the negotiating buyer and seller may be displayed on their axis, but are unavailable to the rest of the market players. During the negotiation, an indication that a negotiation is ongoing may be displayed to the rest of the market players, but in order to not provide any further information associated with the private negotiation, there is no change in the position of all the market players on the axis, including that of the negotiating players. Only when a deal is reached may the GUI display on the axis of all the market players the result of the negotiations (price and quantity), or on the contrary, if a deal is not reached, may inform all the market players by removing the indication that a negotiation is ongoing. Optionally, multiple negotiations may go on between a buyer and multiple sellers or multiple buyers and one seller, with each negotiation potentially having different conditions. Optionally, a market player may enter into a private negotiation with a counterpart without first posting an offer on the axis.

The GUI may additionally allow the market players to take actions which may be displayed on the axis to the rest of the market players. An example of such an action may include a player displaying on the axis a notification that he or she cannot modify their offer. Another action may include a player displaying on the axis that, although they posted an offer, they are no longer open to trade. Another action may include a player who had previously indicated that they are no longer open to trade repealing that action by indicating a new willingness to trade.

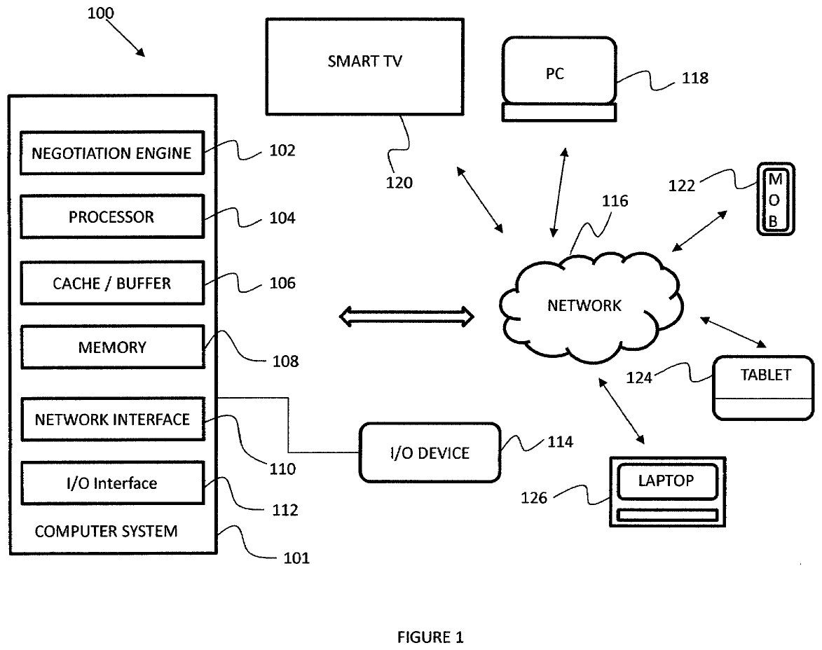

Reference is now made to FIG. 1 which schematically illustrates a block diagram of an exemplary axis negotiation system (ANS) 100 which may be used to practice the teachings disclosed herein, according to an embodiment of the present invention. ANS 100 may include a computer system 101 including a Negotiation Engine (NE) 102, a processor 104, a cache/buffer 106, a memory 108, a network interface 110, an I/O interface 112, at least one I/O device 114. ANS 100 may additionally include a plurality of computing devices, for example, computing devices which may include PCs 118, smart TVs 120, mobile phones 122, tablets 124, and laptops 126.

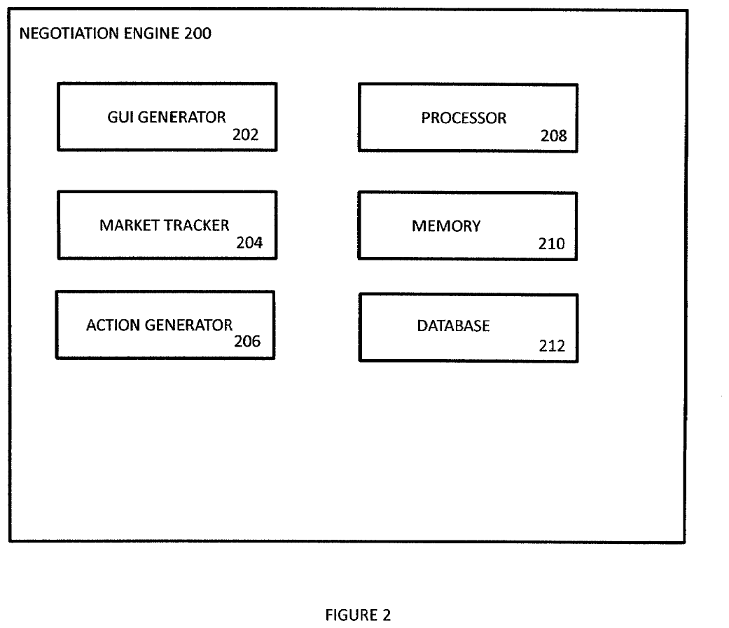

NE 102 may provide the trading platform for the buyers and sellers including the GUI used by all the market players to present their buying or selling offers on the displayed axis and to negotiate trades. The GUI may be implemented in the plurality of computing devices 118-126. The components of NE 102 and its functioning is described in greater detail hereinafter with reference to NE 200 shown in FIG. 2 and associated description.

Processor 104 may be a computing device for executing hardware instructions or software, and may include those stored in memory 108. Processor 104 may be any custom made or commercially available processor, a central processing unit (CPU), an auxiliary processor among several processors associated with computer system 101, a semiconductor based microprocessor (in the form of a microchip or chip set), a macroprocessor, or generally any device for executing instructions. Processor 104 may include a cache/buffer 106. Processor 104 may be configured to execute instructions stored within memory 108, to communicate data to and from the memory 108, and to generally control operations of computer system 101 pursuant to the instructions.

Memory 108 may include any one or combination of volatile memory elements (e.g., random access memory RAM, such as DRAM, SRAM, SDRAM, etc.) and nonvolatile memory elements (e.g., ROM, erasable programmable read only memory EPROM, electronically erasable programmable read only memory EEPROM, programmable read only memory PROM, tape, compact disc read only memory CD-ROM, disk, diskette, cartridge, cassette or the like, etc.). Moreover, memory 108 may incorporate electronic, magnetic, optical, and/or other types of storage media. Optionally, memory 108 may have a distributed architecture, where various components are situated remote from one another, but may be accessed by processor 104.

The instructions in memory 108 may include one or more separate programs, each of which may include an ordered listing of executable instructions for implementing logical functions. In the example of FIG. 1, the instructions in memory 108 may include any suitable operating system. The operating system may essentially control the execution of other computer programs and may provide scheduling, input-output control, file and data management, memory management, and communication control and related services.

Network interface 110 may serve to connect computer system 101 to a network 116. Network 116 may be an IP-based network for communication between computer system 101 and computing devices 118-126 and may transmit and receive data between the ANS and the computing devices. Optionally, network 116 may be a managed IP network administered by a service provider. Network 116 may be implemented in a wireless fashion, e.g., using wireless protocols and technologies, such as Wi-Fi, WiMAX, etc. Network 116 may also be a packet-switched network such as a local area network, wide area network, metropolitan area network, Internet network, or other similar type of network environment. Network 116 may be a fixed wireless network, a wireless local area network (LAN), a wireless wide area network (WAN) a personal area network (PAN), a virtual private network (VPN), intranet or other suitable network system and may include equipment for receiving and transmitting signals. Network 116 may be a mobile phone network.

I/O interface 112 may serve to output processed data to an output device connected to computer system 101 and to receive data entry from an input device, both devices shown generically in the figure as I/O device 114. I/O device 114 may include a display, a conventional keyboard and mouse, a scanner, a printer, an imaging device, a microphone, among many other devices which may serve to either output processed data or may be used for data entry. I/O device 114 may further include devices that communicate both inputs and outputs, for example, a network interface card (NIC) or a modulator/demodulator, a radio frequency (RF) or other transceiver, a telephonic interface, a bridge, a router, and the like.

Reference is now made to FIG. 2 which schematically illustrates NE 102, according to an embodiment of the present invention. NE 102 may include a GUI generator 202, a market tracker 204, an action generator 206, a memory 208, a processor 210, and a database 212.

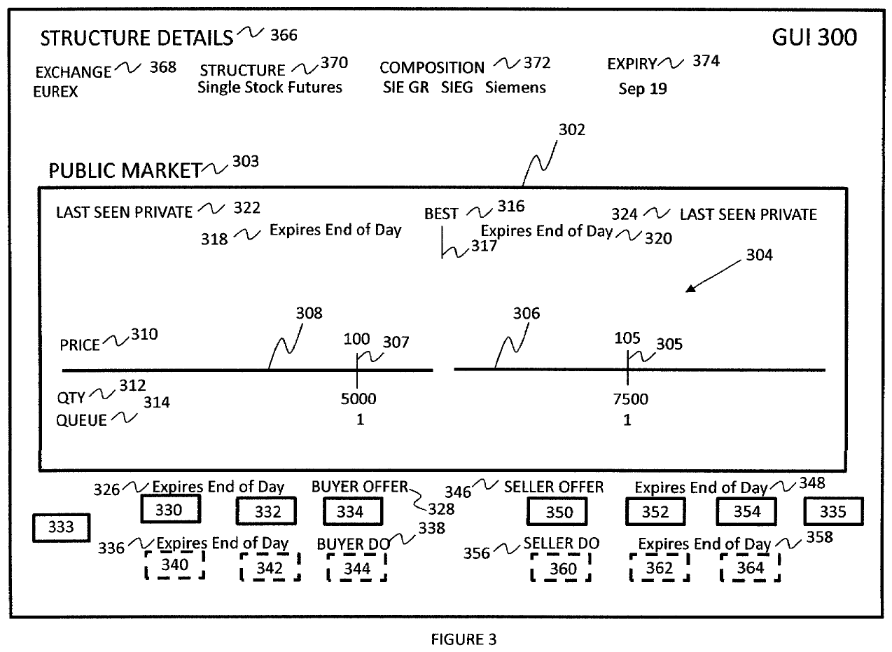

GUI generator 202 may generate the GUIs in the computing devices of all ANS users. It may generate the data displayed by the GUIs and may process data input by a user through the user's computing device GUI for display on the GUIs of the other users' computing devices. It may also serve to interface between the GUIs of the computing devices and the other components in NE 200, including market tracker 204 and action generator 206. A description of an exemplary GUI is provided further on below with reference to FIG. 3.

Market tracker 204 may interface with GUI generator 202 to track all buyer and seller offers, to update offers, and to retain previous offers, all of which may be displayed to all the users through their computing device GUI. Market tracker 204 may additionally track real-time prices product and services from external market sources, for example, from securities and financial instruments markets, currency markets, commodities markets, food markets, among others. Market tracker 204 may provide the external market information to GUI generator 202 which may display the information to all the users through their computing device GUI. Market tracking information used by market tracker 204 may be internally stored inside the market tracker or alternatively, may be stored in database 212. The stored market information may be retained permanently, or may be stored for a predetermined amount of time, for example, until the end of a trading day, for a week, a month, a year, or longer.

Action generator 206 may also interface with GUI generator and may process negotiation actions received from users and may generate the notifications which may be displayed on the GUI axis of the computing device. The negotiation actions may be input by the users through their computing device GUI and, based on the type of action, action generator 206 may instruct GUI generator 202 to display the respective notification on the GUI of all user computing devices or only some of the computing device (for example on two computing devices, one of the highest price buyer and one of the lowest price seller).

Processor 208 may control the operation, including the interfacing, of all components in NE 200 and may interface with processor 104 in computer system 101 for data transfer between the NE and other components of the computer system. In some embodiments, the functions carried out by processor 208 may be provided by processor 104. The instructions required by processor 208 to execute its control and interfacing functions may be stored in memory 210.

Database 212 may store market information which may include historical data per product type or service, including trading prices, user offers, deals closed, and actions taken by users, among other data which may be used in trading platforms and which may also be used to encourage negotiations between users. Database 212 may additionally include details associated with each ANS user, for example, user registration information, user authentication information, user payment information, user transaction information, among other user information generally collected in subscriber-based on-line trading platforms.

Reference is now also made to FIG. 3 which schematically illustrates an exemplary layout for GUI 300 which may be used with all ANS user computing devices, according to an embodiment of the present invention.

GUI 300 may include an axis-display window 302 in which may be displayed an axis 304. Axis 304 may be used to graphically display information related to all offers made by buyers and sellers associated with a specific product or service. Axis 304 may be divided into two sections, a section 306 and an opposing section 308. Section 306 may display the sales offers made by the sellers and section 308 may display the buying offers made by all buyers. The sales offers may be shown by ticks in section 306, for example tick 305 which may be associated with a particular offer made by a specific seller, and the buyer offers by ticks in section 308, for example tick 307, which may be associated with a particular offer made by a specific buyer. Above tick 305 may be displayed the seller's price offer, for example 105, and above tick 307 may be displayed the buyer's price offer, for example 100. Below tick 305 may be displayed the quantity of the product or service that the seller has available for selling, for example 7500, and tick 307 may be displayed the quantity of the product or service that the buyer is interested in purchasing, for example 5000. Also shown below tick 305 are the number of sellers who offered the same price, for example 1 indicating that there are no other sellers selling at the same price, and the number of buyers offering to buy at the same price is also shown below tick 307, again in this example 1. Axis 304 may additionally include labels to assist the user to better interpret the information above and below the ticks, for example, PRICE 310 above axis 304, and QTY 312 and QUEUE 314 below the axis.

Also displayed in axis-display window 302 may be, during a private negotiation between a buyer and a seller, the last price privately offered by the buyer which may be displayed below the label LAST SEEN PRIVATE 322 and the last price offered by the seller which may be displayed below the label LAST SEEN PRIVATE 324. Information displayed to a buyer and a seller during a private negotiation is privy to the negotiating buyer and seller and is not displayed on the GUI of the rest of the buyers and sellers.

Additionally displayed in axis-window 302 may be the highest buyer price presently being offered in the market and the lowest selling price presently being offered in the market. These may be displayed below the label BEST 316, the buyer best price to the left of line 317 (corresponding with section 308) and the seller best price to the right of line 317 (corresponding with section 306). The best prices shown may vary as deals are closed and buyers and sellers leave the market, or as new buyers and sellers enter the market with offers, as a buyers and sellers revise their offers publicly. Optionally, the best buyer price and best seller price of the day may be displayed. Also displayed in axis-window 302 may be the duration of an offer by a buyer and that of a seller. For example, a buyer's offer may terminate at the end of a business day or trading day and may be indicated by the label EXPIRES END OF DAY 318, and the offer of a seller may terminate, as per this example, also at the end of the day as indicated by the label EXPIRES END OF DAY 320. Notwithstanding, each buyer and seller may stipulate the duration of an offer, which may be in minutes, hours, days, or months. Upon expiration of the offer, the offer may either be removed from axes 304 or may remain on the axes for market reference purposes but not engaged in trading.

GUI 300 may additionally display information such as for example, a label PUBLIC MARKET 303 to inform all the users that the information being displayed in axis-window 302 may be viewed by all the buyers and sellers. Also displayed may be details about the product or service being traded, as indicated by the label STRUCTURE DETAILS 366 and under which (or in place of) may be indicated the product or service. As ANS 100 may include a trading platform for trading securities and other financial instruments, also included may be labels, for example, EXCHANGE 368, STRUCTURE 370, and COMPOSITION 372, as well as EXPIRY 374, to describe the details of the security or financial instrument to be negotiated, for example as shown EUREX, Single Stock Futures, SIE GR SIEG Siemens, September 19.

GUI 300 may additionally include data entry locations for a user to input either the user's buyer offer as indicated by the label BUYER OFFER 328 or a seller offer as indicated by the label SELLER OFFER 346. A user who is a buyer may input the price information and quantity to be displayed on axes 304 and to be represented by a tick and may additionally input the duration of the offer to be displayed inside axis-window 302. The buyer, for example, may input the buying price in field 334, the quantity in field 332, and the duration of the buying offer in field 330. The seller, for example, may input the selling price in field 350, the quantity in field 352, and the duration of the seller offer in field 354. For private negotiations, GUI 300 may additionally include data entry locations for a user to input either the user's direct buyer offer associated with the private negotiation, as indicated by the label BUYER DO 338, or a seller direct offer associated with the private negotiation, as indicated by the label SELLER DO 356. The buyer, for example, may input the direct buying price in field 344, the quantity in field 342, and the duration of the direct buying offer in field 340. The seller, for example, may input the direct selling price in field 360, the quantity in field 362, and the duration of the seller offer in field 364. The duration of the offers input by the buyer and the seller when offering in the public market where it is shown to all the buyers and sellers may be displayed, for example by the label Expires End of Day 326 for the buyer's price offer, and by the label Expires End of Day 348 for the seller's price offer. For a private negotiation, for example by the label Expires End of Day 336 for the buyer's price offer, and by the label Expires End of Day 358 for the seller's price offer. The data input by a user into the buyer data input fields or the seller data input fields may optionally remain displayed to the user inside the fields during a trading session.

GUI 300 may additionally include negotiation action buttons which may be associated with action generator 206 and which may allow a buyer and a seller to negotiate privately and may allow a buyer or a seller to carry out other actions, and may allow a buyer and a seller to otherwise communicate between themselves in order to attempt to secure a deal without requiring a verbal exchange, merely by actuating the buttons. The negotiation action buttons, which may be selected by a buyer through action button 303, and by the seller through action button 305, may allow the buyer or the seller to carry out the following actions:

a. communicate to the parties in a negotiation that the buyer or seller (whoever activates the button) wants to repeat the offer shown by displaying the respective notification on the axis (button RPT);

b. communicate to all the users that the buyer or seller cannot improve the price by displaying the respective notification on the axis, (button STK);

c. communicate to a counterpart in a private negotiation an offer to meet in the middle of the buying and selling offer by displaying the respective notification on the axis (button MIM);

d. communicate to all the users that the offer may be viewed by all (remains displayed on axis 304) but withdrawn from trading communicate by displaying the respective notification on the axis (button NS);

e. communicate to all users that a withdrawn offer is revived and may be traded by displaying the respective notification on the axis (button REV);

f. privately communicating to a counterpart who has withdrawn (NS) a query as to whether there is a possibility to trade with him or her and displaying the respective notification on the axis (are you there, button RUT);

g. privately communicating to a counterpart with the best offer an improved offer and displaying the respective notification on the axis (button DO); and

h. privately communicating to a counterpart a time duration for an improved offer after which the improved offer will expire and displaying the respective notification on the axis (button LS).

It may be appreciated by the skilled person that the GUI layout shown in FIG. 3 may be modified to include more or less information, or different type of information depending on the product or service being traded, or that the arrangement used for information display and data entry may differ from that shown in the layout. The skilled person may additionally realize that the axis does not necessarily have to be positioned horizontally and may be positioned vertically or at an angle, with one section used to display buyer offers and the opposing section used to display seller offers. The skilled person may further realize that it may not be important which section is used to display the seller offers and which section is used to display the buyer offers so long as the seller offers and the buyer offers are displayed in separate opposing sections, or whether the price information, quantity and queue information are on separate sides of the axis as shown, or on the same side, or otherwise arranged.

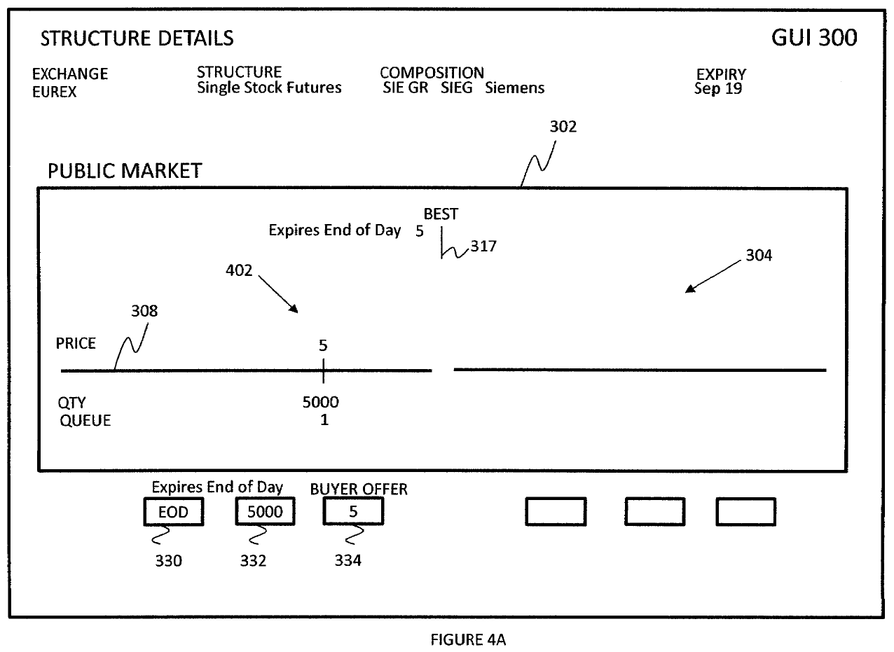

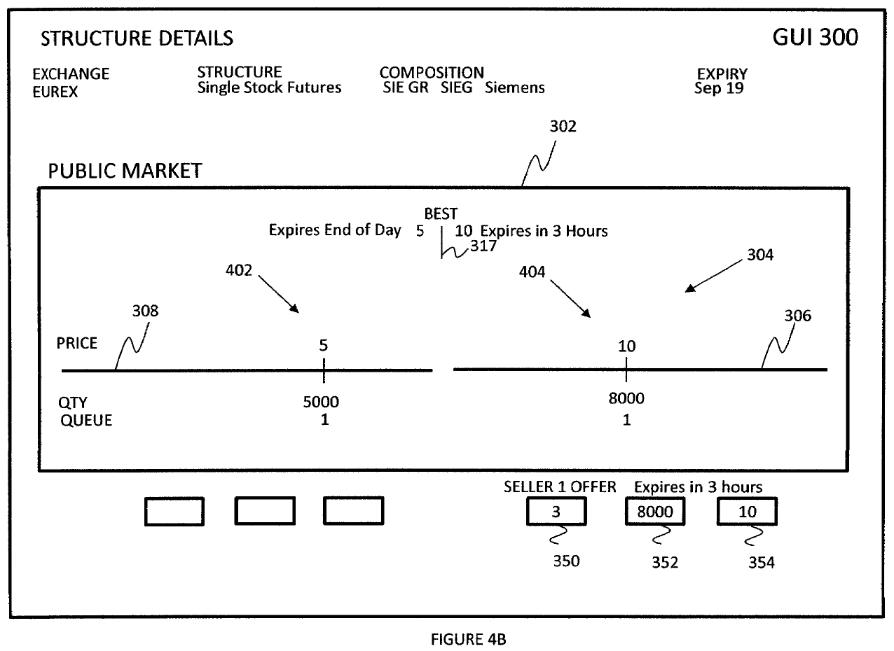

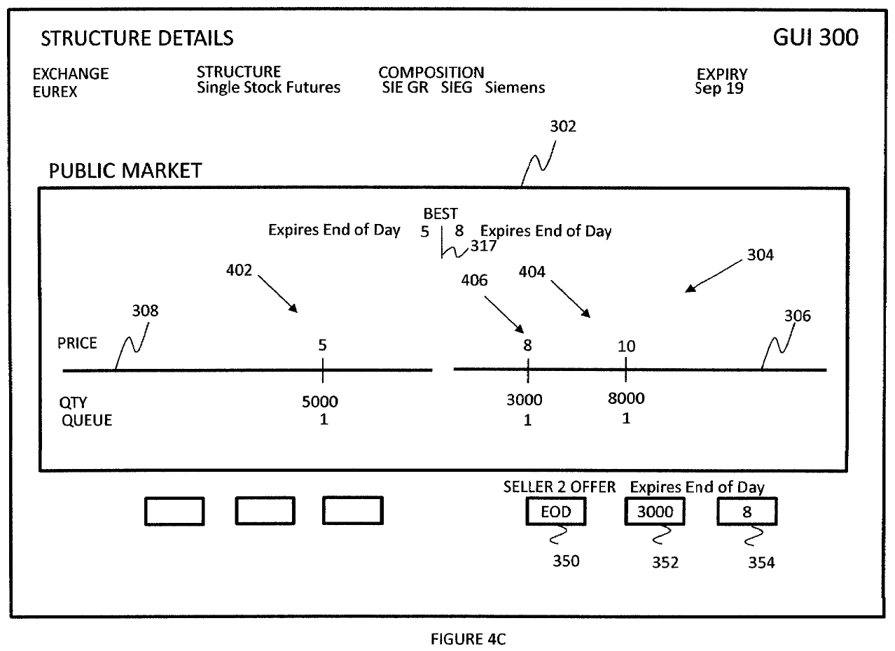

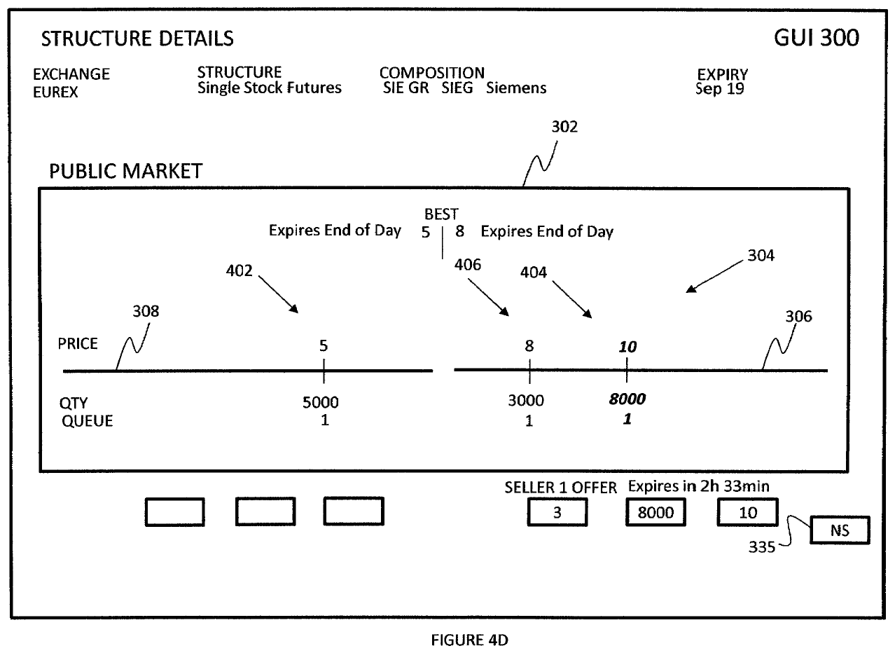

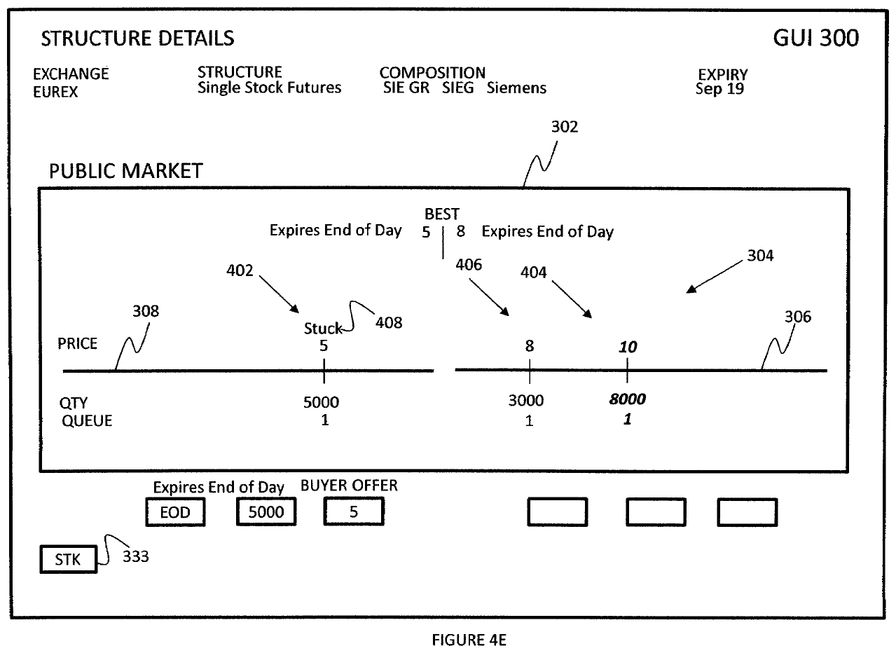

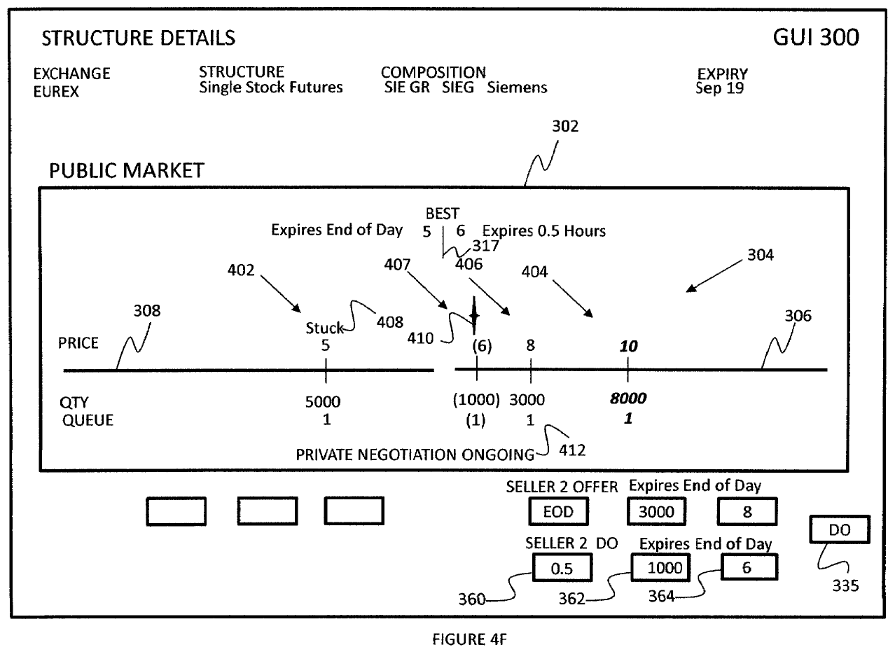

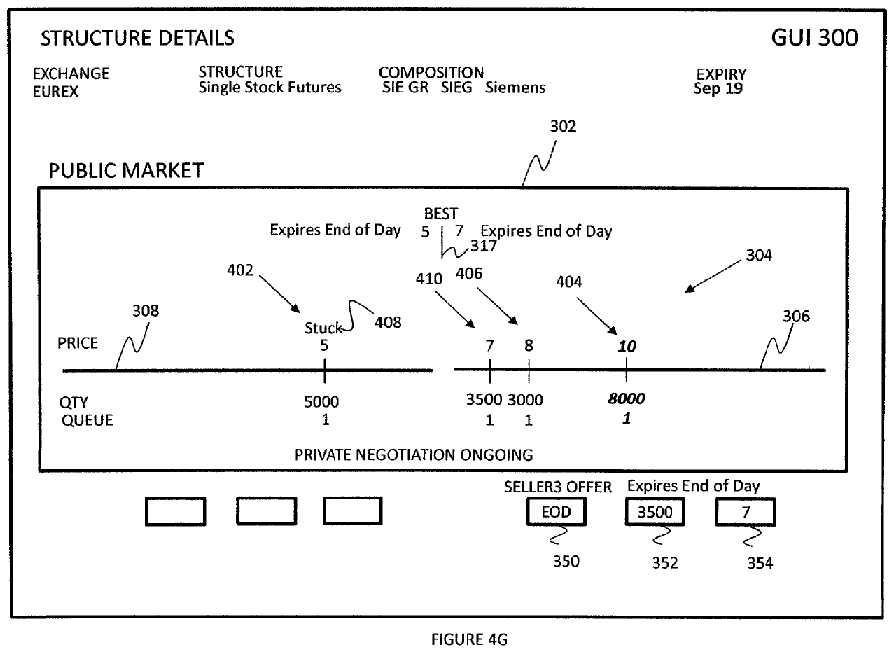

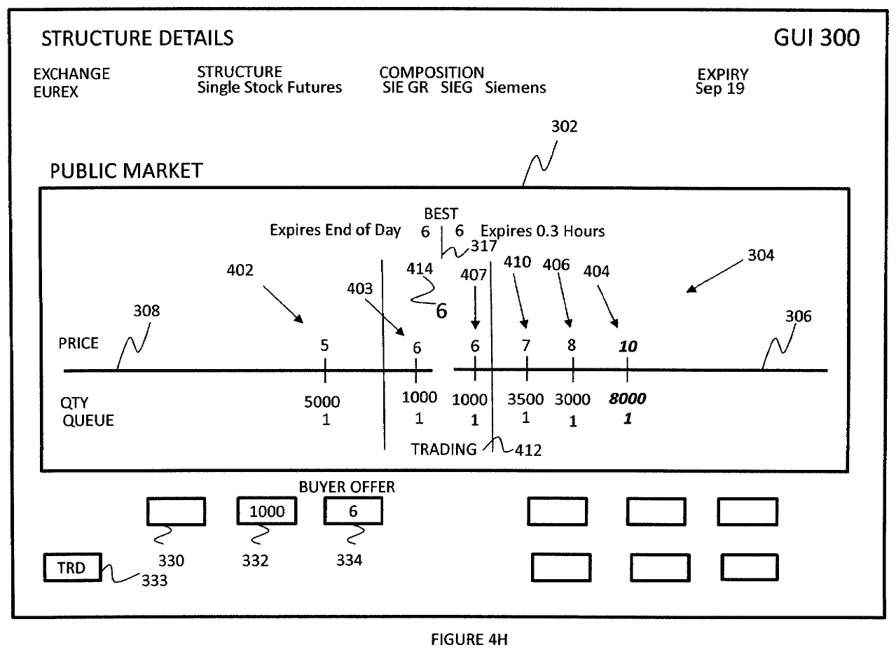

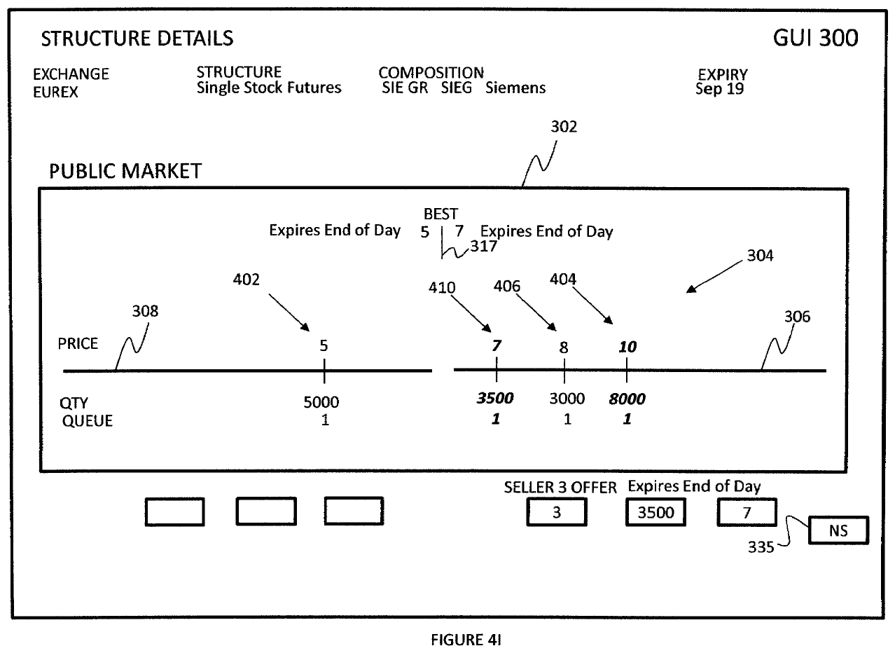

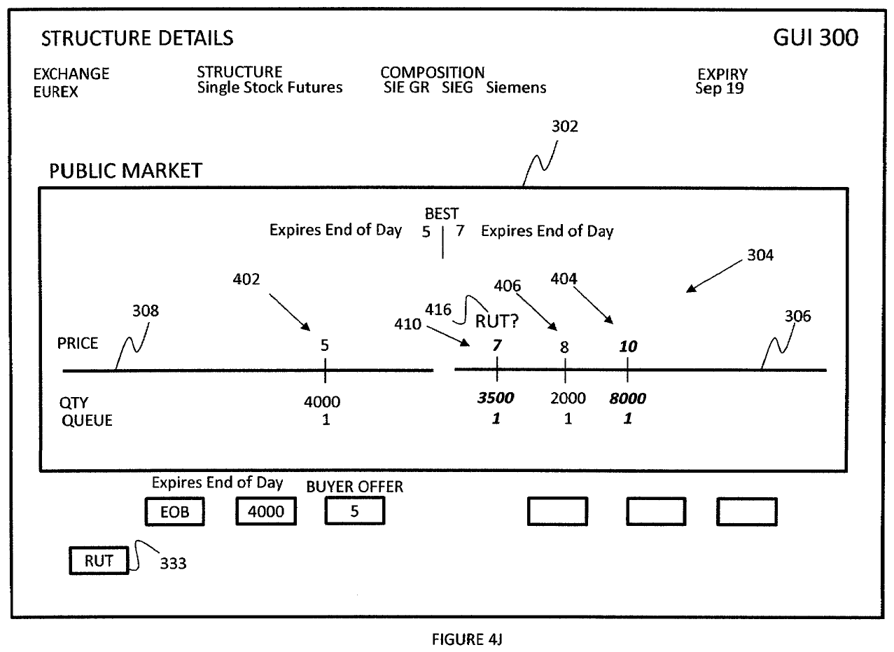

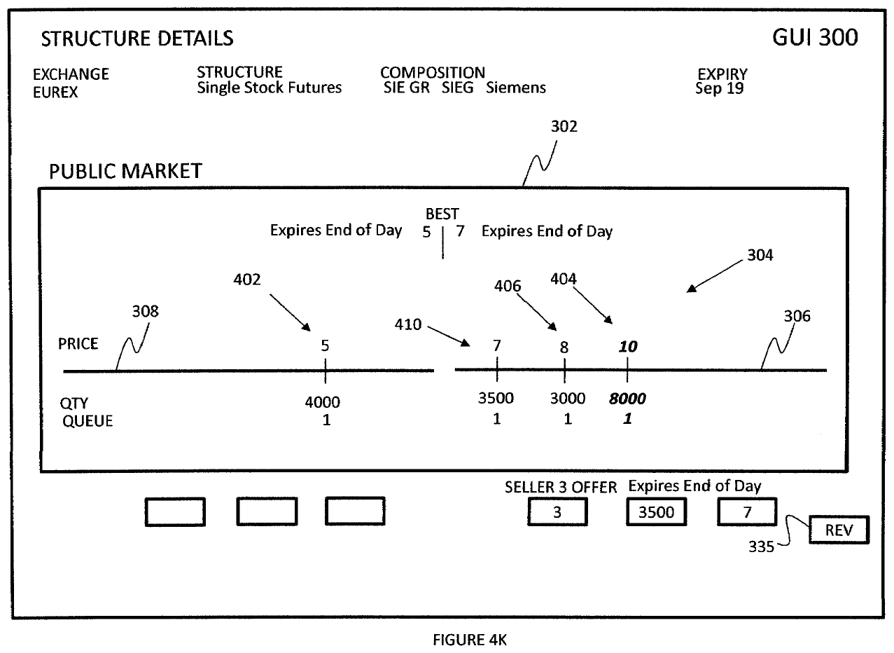

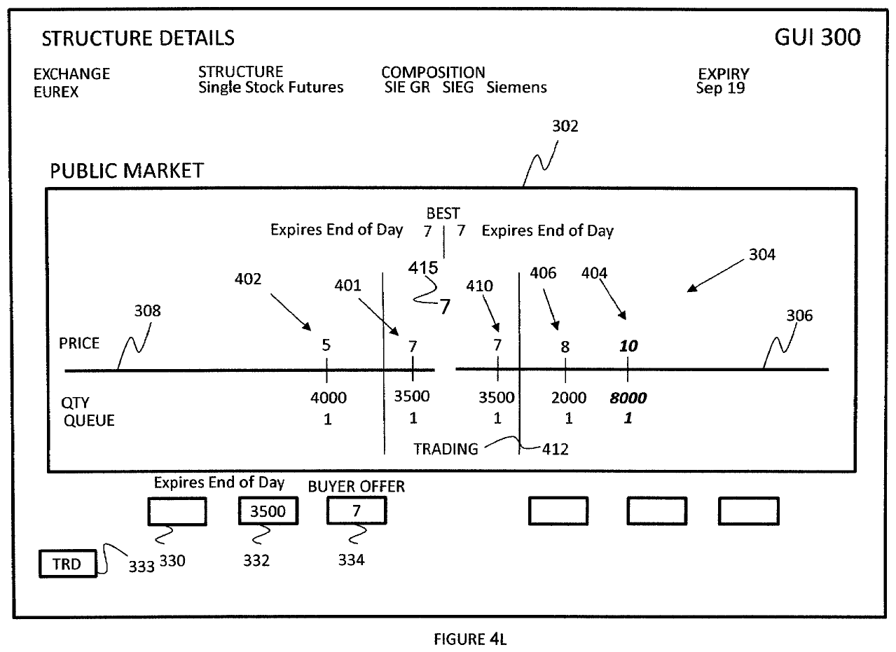

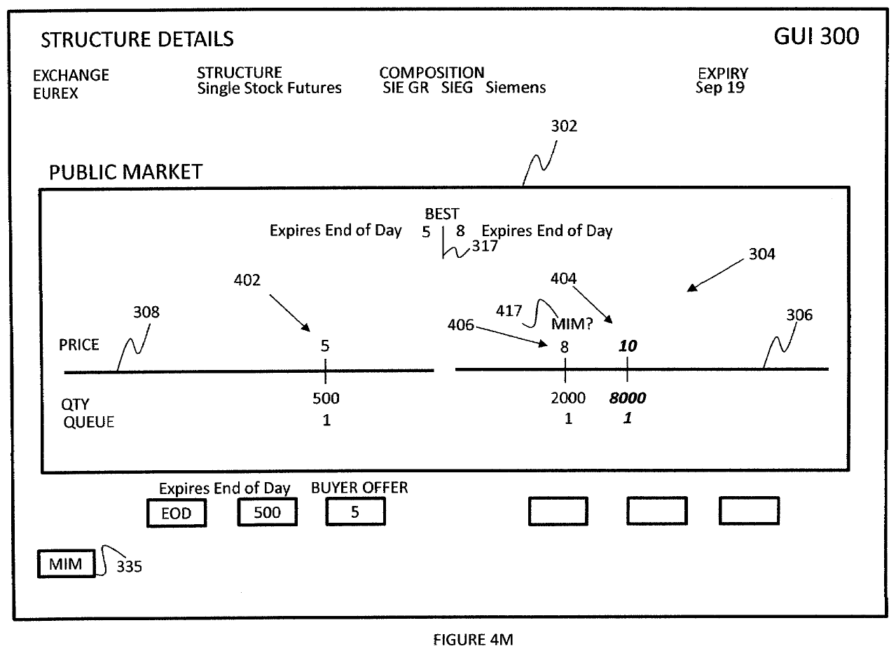

Reference is now made to FIGS. 4A to 4M which schematically illustrate the operation of ANS 100 in an exemplary trading session which includes negotiations between users, as visualized on GUI 300 of the users, according to an embodiment of the present invention. The figures are intended to show the operation of the ANS in different possible scenarios which may occur during a trading session and are not intended to be limiting in any way or form. The skilled person will immediately realize that there may be a countless number of scenarios which may occur during trading sessions involving multiple market players and that the ANS may be used in all of these scenarios.

The exemplary trading session described may be a financial instruments trading session and, as may be appreciated in the figures, GUI 300 of all the users, for exemplary purposes, display STRUCTURE DETAILS including EUREX as the EXCHANGE, Single Stock Futures as the STRUCTURE, SIE GR SIEG Siemens as the COMPOSITION, and September 19 as the EXPIRY.

In FIG. 4A, in a first scenario in the trading session, a buyer (BUYER) may input an offer to buy futures through GUI 300 in his or her computing device. In field 334, the buyer may input an offer to buy at a price of 5, in field 332 the buyer may input 5000 as the required quantity of futures, and in field 300 the buyer may input that the offer is valid until the end of the day (EOD). The offer may be immediately displayed on all market player computing device GUIs inside axis-window 302 on section 308 of axis 304 as buyer offer 402 and may include a tick with the number 5 above the tick indicative of the price, the number 5000 below the tick indicative of the quantity, and the number 1 below the tick indicative that there is no queue and that there is no other buyer at the same price. Optionally, if there are no additional buyers (or sellers) at the same price level, the number associated with the queue may not be shown. Also may be displayed in axis-window 302 the number 5 under BEST and to the left of line 317 indicative that this is the best buyer price offer so far, and also to the left of the line may be indicated that the offer expires at the end of the day.

In FIG. 4B, in a second scenario in the trading session, responsive to the buyer's offer, a seller (SELLER 1) may input an offer to sell futures through GUI 300 in his or her computing device. In field 354, the seller may input an offer to sell at a price of 10, in field 352 the seller may input 8000 units as the quantity available for sale, and in field 350 the seller may input that the offer is valid for 3 hours. The offer may be immediately displayed on all market player computing device GUIs inside axis-window 302 on section 306 of axis 304 as seller offer 404 and may include a tick with the number 10 above the tick indicative of the price, the number 8000 below the tick indicative of the quantity, and the number 1 below the tick indicative that there is no queue and that there is no other buyer at the same price. Also now may be displayed in axis-window 302 the number 10 under BEST and to the right of line 317 indicative that this is the best seller price offer so far, and also to the right of the line may be indicated that the offer expires in 3 hours. In addition to the seller's offer, buyer offer 402 may continue to be displayed on section 308 and under BEST to the left of line 317 the price and the duration of the offer.

In FIG. 4C, in a third scenario in the trading session, responsive to the buyer's offer and the seller's offer, a second seller (SELLER 2) may input an offer to sell futures through GUI 300 in his or her computing device. In field 354, the seller may input an offer to sell at a price of 8, in field 352 the seller may input 3000 units as the quantity available for sale, and in field 350 the seller may input that the offer is valid to the end of the day. The offer may be immediately displayed on all market player computing device GUIs inside axis-window 302 on section 306 of axis 304 as seller offer 406 and may include a tick with the number 8 above the tick indicative of the price, the number 3000 below the tick indicative of the quantity, and the number 1 below the tick indicative that there is no queue and that there is no other buyer at the same price. Also now may be displayed in axis-window 302 the number 8 under BEST and to the right of line 317 indicative that this is the best seller price offer so far, and also to the right of the line may be indicated that the offer expires at the end of the day. In addition to the seller's offer, buyer offer 402 may continue to be displayed on section 308 and under BEST to the left of line 317 the price and the duration of the offer. Also seller offer 404 may continue to be displayed on section 306.

In FIG. 4D, in a fourth scenario, SELLER 1 may decide not to continue trading in view that SELLER 2 is offering a lower price and may decide to withdraw from trading while leaving seller offer 404 visible to all the market players. SELLER 1 may then select to communicate to all the market players the decision by actuating a button NS 335 in the seller's computing device GUI which may display a notification as a change a color of seller offer 404 (the change is indicated herein by bold and italic lettering) and may be immediately visible to all the market players inside axis-window 302 on section 306 of axis 304. All the other information displayed to the rest of the market players in their GUI 300 may remain the same. As time may have passed since SELLER 1 posted seller offer 404, the seller's GUI 300 may show, for example, that the offer expires in 2 hours 33 minutes.

In FIG. 4E, in a fifth scenario, BUYER may decide to inform the market, including SELLER 2, that the buying price cannot be increased. BUYER may then select to communicate to all the market players indicative of the decision by selecting a button STK 333 in the buyer's computing device GUI which may display a notification “Stuck” 408 above buyer offer 402 and may be immediately visible to all the market players inside axis-window 302 on section 308 of axis 304. All the other information displayed to the rest of the market players in their GUI 300 may remain the same.

In FIG. 4F, in a sixth scenario, SELLER 2 may decide that a certain quantity of the total quantity of futures being sold may be reduced in price and may decide to privately make an offer. Private (or direct) offers may be processed by ANS 100 so that they are automatically directed to the buyer or the seller whose difference in price or spread is the smallest relative to the counterparty (i.e. to the buyer with the highest buying price and the seller with the lowest selling price). In the example, there is only one buyer (BUYER) so that the direct offer made by SELLER 2 is automatically routed by the ANS to BUYER.

For example, SELLER 2 decides that 1000 futures may be sold at 6 and may input the price of 6 in direct offer field 364, may input 1000 in direct offer field 362, and may input a direct offer time duration of 0.5 hours in field 360. SELLER 2 may then press activation button DO 335 and the direct offer may be automatically displayed in axis-window 302 in the SELLER 2 GUI 300 and the BUYER GUI 300 as seller offer 407 on section 308 of axis 304. Seller offer 407 may include an indication 410 associating the offer with a direct offer and may include a tick with the number (6) above the tick indicative of the price, the number (1000) below the tick indicative of the quantity, and the number 1 below the tick indicative that there is no queue and that there is no other seller at the same price. Also now may be displayed in axis-window 302 the number 6 under BEST and to the right of line 317 indicative that this is the best seller price offer so far, and also to the right of the line may be indicated that the offer expires in 0.5 hours. In addition to the seller's offer, buyer offer 402 may continue to be displayed on section 308 and, under BEST to the left of line 317 the buyer offer price and the buyer offer duration. Also seller offer 404 and original seller offer 406 may continue to be displayed on section 306.

Direct offers are privy to the negotiating parties and are not displayed on the GUIs of the rest of the market players. Displayed on the GUI 300 of the rest of the market players may be axis-window 302 with axis 304 and may show buyer offer 402, seller offer 404 and seller offer 406. Axis-window 302 may also show under BEST the price in buyer offer 402 and seller offer 406. Axis-window 302 may also display the message PRIVATE NEGOTIATION ONGOING 412 to notify the rest of the market players of the direct offer.

In FIG. 4G, in a seventh scenario in the trading session, a third seller (SELLER 3) may input an offer to sell futures through GUI 300 in his or her computing device. In field 354, the seller may input an offer to sell at a price of 7, in field 352 the seller may input 3500 units as the quantity available for sale, and in field 350 the seller may input that the offer is valid to the end of the day. The offer may be immediately displayed on all market player computing device GUIs inside axis-window 302 on section 306 of axis 304 as seller offer 410 and may include a tick with the number 7 above the tick indicative of the price, the number 3500 below the tick indicative of the quantity, and the number 1 below the tick indicative that there is no queue and that there is no other buyer at the same price. Also now may be displayed in axis-window 302 the number 7 under BEST and to the right of line 317 indicative that this is the best seller price offer so far, and also to the right of the line may be indicated that the offer expires at the end of the day. In addition to the seller's offer, buyer offer 402 may continue to be displayed on section 308 and under BEST to the left of line 317 the price and the duration of the offer. Also seller offer 404 and seller offer 406 may continue to be displayed on section 306.

In FIG. 4H, in an eighth scenario, BUYER and SELLER 2 may negotiate a trade of the 1000 futures which SELLER 2 offered at a reduced price through the direct offer. As previously described, axis-window 302 with the direct offer details may be privy only to BUYER and SELLER 2 and not to the rest of the market. BUYER may decide to accept the direct offer made by SELLER 2 and may input the buying price of 6 in field 334 and the quantity of 1000 in field 332. Field 330 may be left empty as the ASN may automatically close the deal when buyer and seller conditions are the same. BUYER may then select activation button TRD 333 and the counteroffer (in this case, the same conditions offered by SELLER 2) may be automatically displayed in axis-window 302 in the SELLER 2 GUI 300 and the BUYER GUI 300 as buyer offer 403 on section 308 of axis 304. Buyer offer 403 may include a tick with the number 6 above the tick indicative of the price, the number 1000 below the tick indicative of the quantity, and the number 1 below the tick indicative that there is no queue and that there is no other buyer at the same price. Also now may be displayed in axis-window 302 the number 6 under BEST and to the left of line 317 indicative that this is the best buyer price offer so far. In addition to the buyer's offer, buyer offer 402 may continue to be displayed on section 308. Under BEST to the right of line 317 the seller direct offer price and the direct offer time duration remaining may also be displayed. Also seller offer 404 and original seller offer 406 may continue to be displayed on section 306, as well as seller offer 410 as SELLER 3 may have made the offer while BUYER and SELLER 2 were negotiating.

As BUYER and SELLER 2 have agreed on the same conditions and buyer offer 403 is equal to seller offer 407, as shown respectively on sections 308 and 306, ANS 100 may automatically close the deal and the results of the trade may be shown to the rest of the market players. Displayed on the axis-window 302 of their GUI 300 (also on that of SELLER 2 and BUYER) may be, for example, a message TRADING 412, the closing price 6 414, and the terms of the trade (price and quantity) which may be displayed by showing buyer offer 403 and seller offer 407.

In FIG. 4I, in a ninth scenario, while BUYER and SELLER 2 may have been negotiating, SELLER 3 may decide to withdraw from trading while leaving seller offer 410 visible to all the market players. SELLER 3 may then select to communicate to all the market players of the decision by selecting button NS 335 in the seller's computing device GUI which may change the color of seller offer 410 (the change is indicated herein by bold and italic lettering) and may be immediately visible to all the market players inside axis-window 302 on section 306 of axis 304. All the other information displayed to the rest of the market players in their GUI 300 may remain the same as displayed in FIG. 4G.

In FIG. 4J, in a tenth scenario, optionally following BUYER and SELLER 3 respectively revising the quantity of futures in their buying offer 402 and selling offer 406 as a result of the trade (buyer offer 402 now shows 4000 instead of 5000 and seller offer 406 now shows 2000), BUYER may still be looking to buy 4000 futures. BUYER may see on axis 304 that SELLER 3 has the best seller offer but that he or she has withdrawn from trading. BUYER may then decide to communicate with an “are you there” action which may be automatically displayed by ANS 100 only on axis-window 302 of BUYER and SELLER 3 (as seller is the best offer) by selecting button RUT 333. For example, the action may be displayed as notification RUT? 416 above the tick associated with seller order 410. The RUT? 416 may not be seen on the GUI 300 of the rest of the market players.

In FIG. 4K, in an eleventh scenario, responsive to seeing RUT? 416, SELLER 3 may decide to return to the trading as BUYER is seeking to buy more futures and has contact the seller. SELLER 3 may then communicate to all the market players, inclusive of BUYER, the decision to return by selecting button REV 335 in the seller's computing device GUI which may change the color of seller offer 410 (the change is indicated herein by removing the bold and italic lettering) back to its original “active” color and may be immediately visible to all the market players inside axis-window 302 on section 306 of axis 304.

In FIG. 4L, in a twelfth scenario, BUYER and SELLER 3 may privately negotiate a trade of the 3500 futures which SELLER 3 is offering by the buyer accepting the terms shown in seller offer 410 on section 306 of axis 304. BUYER may input the buying price of 7 in field 334 and the quantity of 1000 in field 332. Field 330 may be left empty as the ASN may automatically close the deal when buyer and seller conditions are the same. BUYER may then press activation button TRD 333 and the counteroffer (in this case, the same conditions offered by SELLER 3) may be automatically displayed in axis-window 302 in the SELLER 3 GUI 300 and the BUYER GUI 300 as buyer offer 401 on section 308 of axis 304. Buyer offer 401 may include a tick with the number 7 above the tick indicative of the price, the number 3500 below the tick indicative of the quantity, and the number 1 below the tick indicative that there is no queue and that there is no other buyer at the same price. Also now may be displayed in axis-window 302 the number 7 under BEST and to the left of line 317 indicative that this is the best buyer price offer so far. In addition to the buyer's offer, buyer offer 402 may continue to be displayed on section 308. Under BEST to the right of line 317 the seller best price and the time duration remaining may also be displayed. Also seller offer 404, seller offer 406, and seller offer 410 may continue to be displayed on section 306.

As BUYER and SELLER 3 have agreed on the same conditions and buyer offer 401 is equal to seller offer 410, as shown respectively on sections 308 and 306, ANS 100 may automatically close the deal and the results of the trade may be shown to the rest of the market players. Displayed on the axis-window 302 of their GUI 300 (also on that of SELLER 3 and BUYER) may be, for example, the message TRADING 412, the closing price 7 415, and the terms of the trade (price and quantity) which may be displayed by showing buyer offer 401 and seller offer 410.

In FIG. 4M, in a thirteenth scenario, optionally following BUYER a revising the quantity of futures in its buying offer 402 as a result of the trade (buyer offer 402 now shows 500 instead of 4000), BUYER may still be looking to buy 500 futures. BUYER may see on axis 304 that SELLER 2 has the best seller offer and may decide to communicate a private “meet in the middle” action which may be automatically displayed by ANS 100 only on axis-window 302 of BUYER and SELLER 2 (as seller is the best offer) by selecting button MIM 335. For example, the action may be displayed as notification MIM? 417 above the tick associated with seller order 406. The MIM? 417 may not be seen on the GUI 300 of the rest of the market players. Should SELLER 2 accept to meet in the middle, a deal may be closed, for example, by BUYER send a private direct offer to SELLER 2 with the middle price of 6.5 and a quantity of 500 futures and the two parties trading on these terms.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type such as a client/server system, mobile computing devices, smart appliances or similar electronic computing device that manipulates and/or transforms data represented as physical, such as electronic, quantities within the computing system's registers and/or memories into other data similarly represented as physical quantities within the computing system's memories, registers or other such information storage, transmission or di splay devices.

Embodiments of the present invention may include apparatus for performing the operations herein. This apparatus may be specially constructed for the desired purposes, or it may comprise a general-purpose computer selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A computer-implemented method of negotiating a trade of a product or a service between a plurality of buyers and sellers, the method comprising:
using a GUI on computing devices of the plurality of buyers and sellers, displaying on said computing devices a one-dimensional axis divided into two sections, a first section to display on said axis offers made by buyers, and an opposing second section to display offers made by sellers;
arranging said buyer offers on said first section in descending order based on the buyer prices, with the buyer offer with the highest price most proximal to said second section and that with the lowest price most distant from said second section;
arranging said seller offers on said second section in ascending order based on the seller prices, with the seller offer with the lowest price most proximal to said first section and that with the highest price most distant from said first section; and
displaying on said computing devices said axis comprising said arranged first section and said arranged second section;
allowing a buyer with the highest price and a seller with the lowest price to negotiate with each other by selecting negotiation actions on said GUI; and
displaying negotiating notifications on said axis responsive to said selecting.

2. A method according to claim 1 further comprising displaying on said first section, for each buyer offer, a buyer price.

3. A method according to claim 1 further comprising displaying on said second section, for each seller offer, a seller price.

4. A method according to claim 1 further comprising displaying on said first section, for each buyer offer, a buying quantity.

5. A method according to claim 1 further comprising displaying on said second section, for each seller offer, a selling quantity.

6. A method according to claim 1 further comprising communicating to the plurality of buyers and sellers that an offer is being withdrawn from trading but will remain displayed on said axis by displaying a notification on said axis.

7. A method according to claim 1 further comprising communicating to the plurality of buyers and sellers that a withdrawn offer is being revived for trading by displaying a notification on said axis.

8. A method according to claim 1 further comprising communicating to the plurality of buyers and sellers that a price is non-negotiable by displaying a notification on said axis.

9. A method according to claim 1 further comprising selecting a direct offer negotiation action on said GUI and displaying an improved offer on said axis only to said highest price buyer and said lowest price seller.

10. A method according to claim 1 further comprising selecting a repeat offer negotiation action on said GUI and displaying a repeated offer on said axis only to said highest price buyer and said lowest price seller.

11. A method according to claim 1 further comprising selecting a “meet in the middle” negotiation action on said GUI and displaying a “meet in the middle” notification on said axis only to said highest price buyer and said lowest price seller.

12. A method according to claim 1 further comprising selecting an “are you there?” negotiation action on said GUI and displaying an “are you there” notification on said axis only to said highest price buyer and said lowest price seller.

13. A method according to claim 1 wherein said one-dimensional axis is horizontally displayed.

14. A method according to claim 1 further comprising said GUI displaying the amount of time the offers of said highest price buyer and of said lowest price seller are valid to the plurality of buyers and sellers.

15. A method according to claim 1 further comprising said GUI displaying the offers of said highest price buyer and of said lowest price seller is valid to the plurality of buyers and sellers.

16. A method according to claim 1 further comprising said GUI displaying a message of an ongoing negotiation to the plurality of buyers and sellers.
